(19) United States
(12) Patent Application Publication
(10) Pub. No.: US 2002/0112649 A1
(43) Pub. Date: Aug. 22, 2002

(54) Material for use in metal casting

(76) Inventor: Brian Robson, Sheffield (GB)

Correspondence Address: TREXLER, BUSHNELL, GIANGIORGI, BLACKSTONE & MARR, LTD., 36TH FLOOR, 105 WEST ADAMS STREET, CHICAGO, IL, 60603, US

(21) Appl. No.: 10/001,595

(22) Filed: Oct. 31, 2001

(30) Foreign Application Priority Data
Dec. 20, 2000 (GB) 0031009.4

(51) Int. Cl. C04B 7/32; C04B 11/00; C04B 28/14

(52) U.S. Cl. 106/692; 106/772

(57) ABSTRACT

A material for use in metal casting comprising an inert refractory filler and a mix of two co-operating binders providing two bonds, the first binder being colloidal silica and the second binder being at least one hydraulic bonding agent.

### FIELD OF THE INVENTION

This invention relates to a material for use in metal casting, either as a moulding mix, eg for the production of ceramic cores and/or block moulds (hereinafter referred to as cores), or as a coating, facing, or filler, eg for primary (pre-investment) and secondary investment in the investment casting (lost wax) process and fine facing for sand moulds and other backing moulds (eg those made from silicate-bonded ceramic grog).

### BACKGROUND OF THE INVENTION

(i) As a Block Moulding and Core Making Material

By careful selection of fillers and bonding materials, cores can be made for casting a range of alloys, including high temperature alloys such as steel.

Cores are usually produced by mixing together ceramic powder, ceramic grain (often fused silica), liquid binder and a catalyst. The resulting slurry is then poured into a mould where it sets. The solid shape is then removed from the mould and fired to a high temperature after which it is ready for incorporation into a mould.

Ceramic cores used in foundries to make cavities in castings can be divided into three types: sand cores which are cheap, readily available and easy to remove after casting, but which can only achieve a rough, granular surface finish, high pressure injection moulded (HPIM) cores which give excellent surface finish, but which are expensive to make and can only be removed by chemical leaching, and low pressure moulded (LPM) or chemically set cores which are a half way house in terms of cost and quality.

Because of their high cost, HPIM cores are used almost exclusively for producing high value products, such as turbine blades and vanes.

Sand cores are used widely and are the mainstay of the general engineering, automotive, pump and valve casting sectors. In recent years however, equipment designs in these sectors have increasingly called for dimensional tolerances and surface finish beyond what is possible using sand cores.

LPM cores have been the preferred way of making high quality impellers and some valve castings, but the LPM process often suffers from high scrap and rework rates which make it uneconomical. It also involves the use of hydrolysed ethyl silicate (HES) which is an alcohol-based binder, containing the industrial solvent isopropyl alcohol, which is being phased out of casting processes wherever possible for environmental and health and safety reasons.

HES is unique among binders used in casting processes in that it forms chemically set bonds at room temperature which are transformed on heating to a different type of bond, without going through a weak stage where one set of bonds is destroyed before the next is formed. This behaviour enables a ceramic shape to be formed in a single operation, following which it can be fired, without detriment, to a high temperature and can have molten steel poured onto it. In some other processes utilising HES, for example shell moulding, alternative techniques and materials have been developed, but in the case of core making and block moulding, the requirements are very specific and no viable alternative has yet been found, despite considerable activity in the field.

The unique combination of properties found in HES cannot be reproduced by any known single binder.

(ii) As a Coating, Facing or Filler

Investment casting uses a disposable pattern, usually wax (hence the ‘lost wax’ process) but other materials are possible including various plastic materials which are becoming increasingly common when produced by rapid prototyping (RP) techniques. Wax patterns are usually assembled on a wax tree or runner and the whole assembly is coated with layer upon layer of ceramic slurry and stucco, each layer being dried before the next is added. When sufficient layers have been added, the assembly and its ceramic covering is given a final thorough dry and the wax is melted out using superheated steam or by sudden heating in a furnace.

Producing investment casting shells can be a time consuming business if the patterns have any features which are difficult to dry eg deep cavities or slots. One way of overcoming this is to fill the cavities with a suitable chemically set material. If the material is applied directly to the wax pattern before dipping commences this is called pre-investment or primary investment. If one or more investment dip coats is applied prior to filling with the material then it is secondary investment.

### OBJECT OF THE INVENTION

A basic object of the invention is to provide a foundry core capable of replacing LPM as a core manufacturing route, to overcome the main problems associated with HES, ie high scrap and rework rates and environmental concerns, and to be suitable for the other casting applications where HES is used, which are block moulding (also known as the Shaw Process), pre-investment of wax and RP patterns, secondary investment of ceramic shells and fine facing for sand and ceramic grog moulds.

Summary of a First Aspect of the Invention

According to a first aspect of the invention there is provided a material for use in metal casting comprising a mix of inert refractory filler and two co-operating binders providing two bonds, the first binder being colloidal silica and the second binder being at least one hydraulic bonding agent.

Summary of a Second Aspect of the Invention

According to a second aspect of the invention, there is provided a ceramic core and/or mould comprising material of the first aspect.

Summary of a Third Aspect of the Invention

According to a third aspect of the invention, there is provided a slip or slurry comprising material of the first aspect.

In practice, in order to set, hydraulic bonding agents require water and, in the case of invention, the water is provided by the (water-based) colloidal silica. When sufficient water has been extracted by hydraulic bonding agent, the colloidal silica also sets, producing a double set of bonds. Normally colloidal silica sets by evaporating water, but this chemical drying has been found to work just as effectively.

The dual bonded material is strong and suitable for instance for the manufacture of ceramic cores and/or moulds of complex shapes with thin sections. The use of two binder types viz hydraulic bonding agent and colloidal silica in combination in accordance with the invention enables at least one type of bond to be effective at all temperatures throughout the firing cycles used to manufacture cores/moulds, and over the whole temperature range from room temperature to the temperature at which steel is cast, ie around 1600° C.

Furthermore, articles bonded by hydraulic bonding agents alone must be fired very carefully, especially through the temperature regime where combined water of crystallization is evolved. This makes the firing process slow and hazardous. However, when using the dual bonded core in accordance with the invention, ceramic shapes can be fired quickly and safely, making it more cost-effective and repeatable.

### PREFERRED OR OPTIONAL FEATURES OF THE INVENTION

For a core, the inert filler is present as −120 mesh-fused silica, approximately 35% by weight, and 30/50 mesh-fused silica, approximately 40% by weight.

For other uses such as a block mould or a facing other inert fillers may be used eg fused mullite, molochite (Trade Mark).

The hydraulic bonding agent is calcium aluminate cement which is suitable for casting high temperature alloys for instance, for when slurries containing inert filler, calcium aluminate cement and colloidal silica are poured into a die and allowed to set, and the resulting ceramic core shape fired, the core is resistant to molten steel and is suitable for use when casting a wide range of steel or nickel based alloys.

The hydraulic bonding agent is hydratable alumina. Hydratable alumina can be used in combination with calcium aluminate cement to accelerate setting and to improve high temperature properties, or to replace calcium aluminate cement where a lime-free refractory is needed, eg for casting special steels and super alloys.

The hydraulic bonding agent is plaster of paris.

The above hydraulic bonding agents are used singly or in any required combinations.

The material incorporates an accelerator to control setting rate and to allow process cycle times to be reduced. The accelerator selected depends on the type of hydraulic bonding agent being used. With calcium aluminate cement this can be hydratable alumina such as ALPHABOND 300 supplied by ALCOA Industrial Chemicals Europe, or ACTIBOND 2005 supplied by Alcan Chemicals Europe.

The accelerator is present at approximately 4% by weight in a material mix comprising approximately 75% by weight fused silica and approximately 20% by weight calcium aluminate cement.

The material incorporates a single dispersant or mix of dispersants exhibiting differing characteristics. Thus, a single dispersant may for example be Dispex A40 or Dispex N40 supplied by Ciba Speciality Chemicals PLC, which enable the constituents of the material to mix together easily and also allows entrained air to be removed from the mix easily, improving core quality. Two other dispersants are employed in tandem being dispersing alumina M-ADW1, which accelerates the reaction and dispersing alumina M-ADS1, (both available from ALCOA Industrial Chemicals), which retards the reaction, and by adjusting the ratio of each, the setting rate can be accurately controlled.

One preferred material mix is:

SOLID CONSTITUENTS

| | |
|---|---|
| Fused Silica −120 mesh | Approximately 35% by weight |
| Fused Silica 30/50 mesh | Approximately 40% by weight |
| Calcium Aluminate Cement CA 270 | Approximately 20% by weight |
| Hydratable Alumina Alphabond 300 | Approximately 4% by weight |
| Dispersing Alumina M-ADW 1 | Approximately 0.7% by weight |
| Dispersing Alumina M-ADS 1 | Approximately 0.3% by weight |

LIQUID CONSTITUENTS

| | |
|---|---|
| Colloidal Silica SYTON W-50 | Approximately 310 ml per 1 Kg of solid |
| | constituents |

Note that the ratio of M-ADW 1 to M-ADS 1 is not fixed, but will need to be adjusted as required to control setting rate in response to variations in environmental conditions, variations in raw materials, etc.

Firing of cores in accordance with the invention is effected in the region of 1100° C., typically for around four hours, although the exact firing conditions according to this invention are less critical than in competing processes.

What I claim is:

1. A material for use in metal casting comprising an inert refractory filler and a mix of two co-operating binders providing two bonds, a first of said binders being colloidal silica and a second of said binders being at least one type of hydraulic bonding agent.

2. A material as claimed in claim 1, wherein said inert refractory filler is present as −120 mesh-fused silica at approximately 35% by weight, and 30/50 mesh-fused silica at approximately 40% by weight.

3. A material as claimed in claim 1, wherein said colloidal silica is a commercially available colloidal silica, for example SYTON W-50, supplied by DuPont®.

4. A material as claimed in claim 1, wherein said hydraulic bonding agent is any material which sets by absorbing water.

5. A material as claimed in claim 1, wherein said hydraulic bonding agent is calcium aluminate cement.

6. A material as claimed in claim 1, wherein said hydraulic bonding agent is hydratable alumina.

7. A material as claimed in claim 1, wherein said hydraulic bonding agent is plaster of paris.

8. A material as claimed in claim 1, wherein said hydraulic bonding agent is one or more of calcium aluminate cement, hydratable alumina, plaster of paris used singly or in combination.

9. A material as claimed in claim 5, wherein said calcium aluminate cement is approximately 20% by weight in a material mix comprising approximately 75% fused silica or other inert filler.

10. A material as claimed in claim 1, incorporating an accelerator.

11. A material as claimed in claim 10, wherein with calcium aluminate cement as said bonding agent, said accelerator is hydratable alumina.

12. A material as claimed in claim 11, wherein said accelerator is ALPHABOND 300 (ALCOA Industrial Chemicals) or ACTIBOND 2005 (ALCAN Chemicals Europe).

13. A material as claimed in claim 10, wherein said accelerator is present at approximately 4% by weight in a solid material mix comprising approximately 75% by weight fused silica, and approximately 20% by weight calcium aluminate cement.

14. A material as claimed in claim 1 incorporating a dispersant.

15. A material as claimed in claim 14, wherein said dispersant is DISPEX A40 or N40 (Ciba Speciality Chemicals PLC).

16. A material as claimed in claim 14, incorporating two dispersants in tandem, a first of said dispersants being capable of accelerating the setting rate, and a second of said dispersants being capable of retarding the setting rate.

17. A material as claimed in claim 16, wherein said first dispersant is dispersing alumina M-ADW1 and said second dispersant is dispersing alumina M-ADS1 (ALCOA Industrial Chemicals).

18. A material as claimed in claim 1, comprising a mix of:
SOLID CONSTITUENTS

| | |
|---|---|
| Fused Silica −120 mesh | Approximately 35% by weight |
| Fused Silica 30/50 mesh | Approximately 40% by weight |
| Calcium Aluminate Cement CA 270 | Approximately 20% by weight |
| Hydratable Alumina Alphabond 300 | Approximately 4% by weight |
| Dispersing Alumina M-ADW 1 | Approximately 0.7% by weight |
| Dispersing Alumina M-ADS 1 | Approximately 0.3% by weight |

LIQUID CONSTITUENTS

| | |
|---|---|
| Colloidal Silica SYTON W-50 | Approximately 310 ml/1 Kg of solid |
| | constituents |

19. A ceramic core or mould comprising a material as defined in claim 1.

20. A ceramic core or mould as defined in claim 19, formed by firing at approximately 1000° C.-1200° C., depending on duration, typically at 1100° C. for approximately four hours.

21. A slip or slurry comprising material as defined in claim 1.
